(19) United States
(12) Patent Application Publication
(10) Pub. No.: US 2015/0262222 A1
(43) Pub. Date: Sep. 17, 2015

(54) METHOD AND SYSTEM FOR CALCULATING ADVERTISEMENT CONVERSION RATES

(71) Applicant: MasterCard International Incorporated, Purchase, NY (US)

(72) Inventor: Justin X. HOWE, San Francisco, CA (US)

(73) Assignee: MasterCard International Incorporated, Purchase, NY (US)

(21) Appl. No.: 14/208,598

(22) Filed: Mar. 13, 2014

(51) Int. Cl. G06Q 30/02

(52) U.S. Cl. CPC G06Q 30/0246; G06Q 30/0248

(57) ABSTRACT

A method for calculating a click conversion rate includes: storing a plurality of click data entries, each entry including data related to an electronic advertisement including a number of clicks and a consumer identifier associated with a plurality of consumers that have clicked on the related advertisement; receiving a plurality of transaction data entries, each entry including data related to a payment transaction including common merchant data and a common consumer identifier; identifying a specific click data entry where the consumer identifier corresponds to the common consumer identifier and the related advertisement corresponds to the common merchant data; and calculating a conversion rate for the advertisement related to the specific click data entry based on the included number of clicks and a number of the plurality of transaction data entries.

### FIELD

The present disclosure relates to the calculation of click conversion rates, specifically the calculation of a conversion rate of clicks of a web-based advertisement or other electronic advertisement based on transaction data.

### BACKGROUND

As more and more consumers are being connected to the Internet and via more and more methods, the amount of Internet traffic has also increased in volume. Advertisers often seek to capitalize on Internet traffic by providing advertising services to merchants and other entities. In many instances, payment negotiated by the parties involved for Internet advertising may be based on both clicks on a web-based advertisement, as well as successful transactions that are processed as a result of such clicks, referred to as “conversions.” A “click” is a term of art meaning to press a button (physical or virtual) on a mouse or some other input device in order to make something happen on a computer, and in the context of this disclosure, to direct a browser to another network resource by clicking or hovering over a virtual advertisement.

However, such systems may sometimes be susceptible to fraud. For example, the number of clicks on an advertisement may be inflated through fraudulent means, such as by a script that continuously and repeatedly clicks an advertisement. Identifying conversions in such systems may also be difficult. For example, the advertiser may be unable to identify transactions resulting from clicks that are successfully processed and cleared, or the merchant may be unable to associate a cleared transaction as being a result from a click. These types of situations may result in fraudulent clicks and false-positive conversions, which may adversely affect the measurements of the advertisement and its effectiveness.

Thus, the present inventor believes there is a need for a technical solution that utilizes transaction data to calculate click conversion rates and to identify fraudulent or unconverted clicks.

### SUMMARY

The present disclosure provides a description of systems and methods for the calculation of click conversion rates.

A method for calculating a click conversion rate includes: storing, in a click database, a plurality of click data entries, wherein each click data entry includes data related to an electronic advertisement including at least a number of clicks and a consumer identifier associated with a plurality of consumers that have clicked on the related electronic advertisement; receiving, by a receiving device, a plurality of transaction data entries, wherein each transaction data entry includes data related to a payment transaction including at least common merchant data and a common consumer identifier; identifying, in the click database, a specific click data entry where the included consumer identifier corresponds to the common consumer identifier and the related electronic advertisement corresponds to the common merchant data; and calculating, by a processing device, a conversion rate for the electronic advertisement related to the specific click data entry based on the included number of clicks and a number of the plurality of transaction data entries.

A method for calculating a click conversion rate includes: storing, in a consumer database, a plurality of consumer profiles, wherein each consumer profile includes data related to a consumer including at least advertisement clicking history, the advertisement clicking history corresponding to a plurality of electronic advertisements clicked by the related consumer; identifying, in the consumer database, a number of consumer profiles including a common advertisement clicking history; transmitting, by a transmitting device, a purchase history request, wherein the purchase history request includes at least the common advertisement clicking history; receiving, by a receiving device, at least a number of consumers associated with payment transactions corresponding to the common advertisement clicking history in response to the transmitted purchase history request; and calculating, by a processing device, a conversion rate for the plurality of electronic advertisements corresponding to the common advertisement clicking history based on the received number of consumers and the identified number of consumer profiles.

A system for calculating a click conversion rate includes a click database, a receiving device, and a processing device. The click database is configured to store a plurality of click data entries, wherein each click data entry includes data related to an electronic advertisement including at least a number of clicks and a consumer identifier associated with a plurality of consumers that have clicked on the related electronic advertisement. The receiving device is configured to receive a plurality of transaction data entries, wherein each transaction data entry includes data related to a payment transaction including at least common merchant data and a common consumer identifier. The processing device is configured to: identify, in the click database, a specific click data entry where the included consumer identifier corresponds to the common consumer identifier and the related electronic advertisement corresponds to the common merchant data; and calculate a conversion rate for the electronic advertisement related to the specific click data entry based on the included number of clicks and a number of the plurality of transaction data entries.

A system for calculating a click conversion rate includes a consumer database, a processing device, and a receiving device. The consumer database is configured to store a plurality of consumer profiles, wherein each consumer profile includes data related to a consumer including at least advertisement clicking history, the advertisement clicking history corresponding to a plurality of electronic advertisements clicked by the related consumer. The processing device is configured to identify, in the consumer database, a number of consumer profiles including a common advertisement clicking history. The transmitting device is configured to transmit a purchase history request, wherein the purchase history request includes at least the common advertisement clicking history. The receiving device is configured to receive at least a number of consumers associated with payment transactions corresponding to the common advertisement clicking history in response to the transmitted purchase history request. The processing device is further configured to calculate a conversion rate for the plurality of electronic advertisements corresponding to the common advertisement clicking history based on the received number of consumers and the identified number of consumer profiles.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for calculating click conversion rates and identifying fraudulent and unconverted clicks using transaction data accordance with exemplary embodiments.

FIG. 2 is a block diagram illustrating the processing server of FIG. 1 for the calculation of click conversion rates and identification of fraudulent and unconverted clicks in accordance with exemplary embodiments.

FIG. 3 is a flow diagram illustrating a process for identifying fraudulent and unconverted clicks in accordance with exemplary embodiments.

FIGS. 4A and 4B are flow diagrams illustrating processes for calculating click conversion rates in accordance with exemplary embodiments.

FIG. 5 is a diagram illustrating the identification of fraudulent and unconverted clicks for calculation of a conversion rate in accordance with exemplary embodiments.

FIGS. 6 and 7 are flow charts illustrating exemplary methods for calculating click conversion rates in accordance with exemplary embodiments.

FIG. 8 is a flow chart illustrating an exemplary method for identifying fraudulent clicks in accordance with exemplary embodiments.

FIG. 9 is a flow chart illustrating an exemplary method for identifying unconverted clicks in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Identifying Fraudulent and Unconverted Clicks and Calculating Conversion Rates

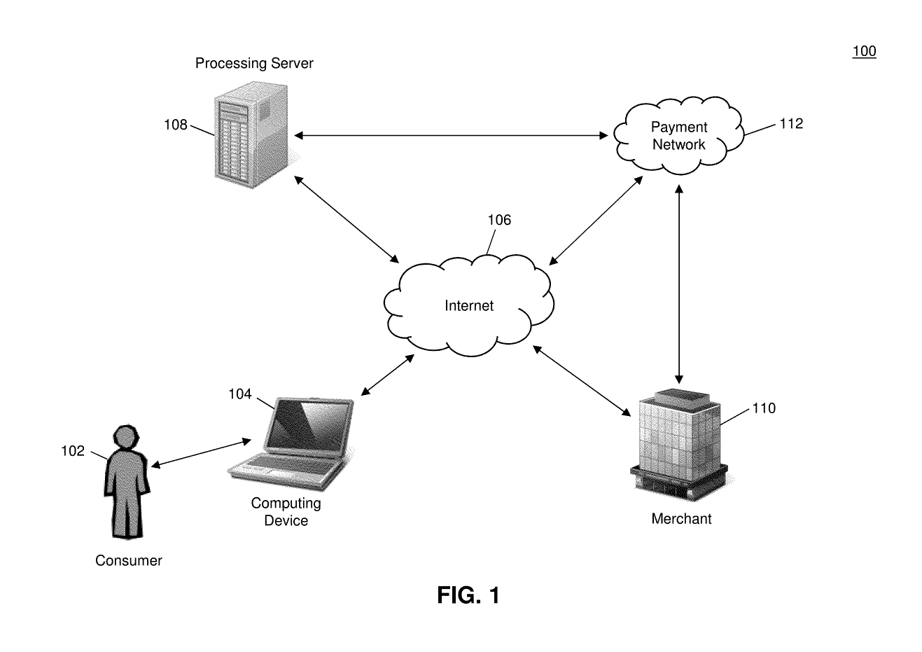

FIG. 1 illustrates a system 100 for the identification of fraudulent and unconverted clicks and the calculation of click conversion rates using transaction data.

The system 100 may include a consumer 102. The consumer 102 may use a computing device 104 to browse websites via the Internet 106. The computing device 104 may be any type of computing device suitable for viewing Internet websites, such as a desktop computer, laptop computer, notebook computer, tablet computer, smart phone, or other suitable device as will be apparent to persons having skill in the relevant art. The computing device 104 may include a web browsing application program or other suitable program used for browsing Internet websites, or for executing an application program that may be configured to display some form of electronic advertisements.

The consumer 102 may view a webpage or application program that includes an advertisement. The advertisement may be any suitable type of electronic advertisement, such as a web page advertisement, and may be provided, monitored, or otherwise managed by a processing server 108. The processing server 108, discussed in more detail below, may be operated by an advertiser, web hosting agency, or other suitable entity and may be used for identifying fraudulent or unconverted clicks of the advertisement and calculating conversion rates for the advertisement.

The advertisement may be included in the webpage and programmed such that, when clicked on by the consumer 102 via the computing device 104, may navigate the web browsing application program on the computing device 104 to a webpage operated by or on behalf of a merchant 110. In some instances, the displayed webpage may be directly associated with products or services indicated in the advertisement. For example, the advertisement may be for a specific purchasable good, which may direct the web browsing application program to a webpage where the good may be purchased once clicked on by the consumer 102. It is noted that electronic advertisements and associated actions based thereon as discussed herein are illustrated as being web page advertisements, but that the functions discussed herein may also be applicable to other suitable types of electronic advertisements, such as advertisements in an application program executed by the computing device 104 via SMS messaging, e-mail, or nearly any other form of electronic advertising, as will be apparent to persons having skill in the relevant art.

The processing server 108 may detect the consumer's click of the advertisement. Methods for detecting the click of an advertisement will be apparent to persons having skill in the relevant art. The consumer 102 may view (e.g., via the computing device 104) the webpage associated with the merchant 110 and may, in some instances, conduct a payment transaction with the merchant 110 after being directed to the webpage via the advertisement. Methods for conducting a payment transaction via the Internet 106 will be apparent to persons having skill in the relevant art.

The payment transaction may be processed by a payment network 112 using traditional systems and methods. Once the payment transaction has been processed, transaction data for the payment transaction may be transmitted to the processing server 108. The processing server 108 may then use the transaction data, using methods discussed in more detail below, to identify fraudulent and unconverted clicks by consumers 102 and to calculate conversion rates of clicks of the advertisement to processed transactions. In some embodiments, the processing server 108 may receive the transaction data for the payment transaction from the merchant 110 (e.g., via a point of sale system of the merchant 110). In some instances, the methods and functions performed by the payment network 112 as discussed herein may be performed by the merchant 110, an acquirer associated with the merchant 110, or other suitable entity. For example, an acquirer may be configured to provide transaction data to the processing server 108 or, as discussed below, identify consumers 102 or microsegments of consumers 102 based on provided criteria.

The use of transaction data by the processing server 108 to identify fraudulent or unconverted clicks or to calculate conversion rates may increase the accuracy of such identifications and calculations. For example, the processing server 108 may identify a computing device 104 as the source of a large number of clicks of an advertisement without any payment transaction being attributed to the computing device 104 or an associated consumer 102, which may indicate the clicks as being fraudulent. In addition to having increased accuracy of conversion rates due to more efficient and accurate identification of fraudulent and unconverted clicks, the processing server 108 may also be able to calculate more accurate conversion rates by associating payment transaction data with browsing data of computing devices 104, using methods discussed in more detail below.

### Processing Server

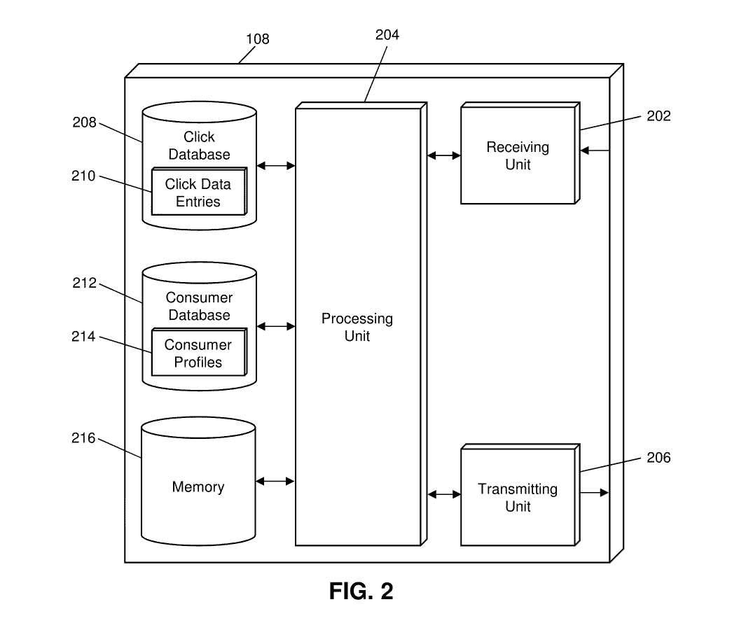

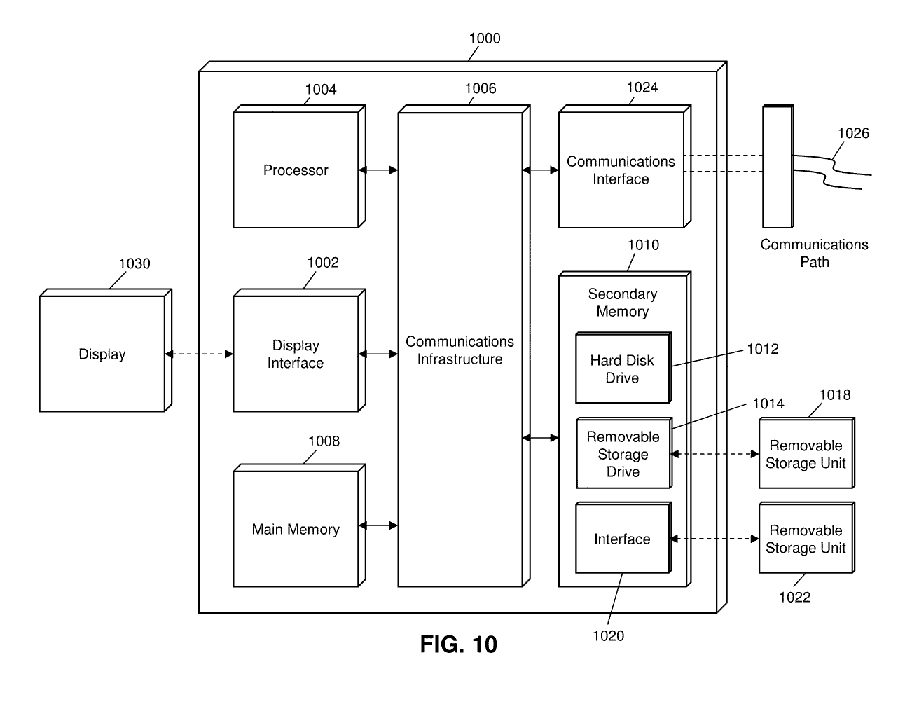

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of processing server 108 suitable for performing the functions as discussed herein. For example, the computer system 1000 illustrated in FIG. 10 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive click data from one or more computing devices 104 via the Internet 106. The click data may include data regarding clicks by a consumer 102 of a computing device 104 of a web page advertisement that is managed by the processing server 108. The processing server 108 may also include a processing unit 204. The processing unit 204 may be configured to store the received click data as a plurality of click data entries 210 in a click database 208 of the processing server 108.

Each click data entry 210 may include data related to a web page advertisement or other electronic advertisement including at least a number of clicks and a consumer identifier associated with a plurality of consumers 102 that have clicked on the related web page advertisement. In some instances, each click data entry 210 may include additional data regarding each click comprising the number of clicks, such as time and/or date data. The consumer identifier may be a unique value associated with a plurality of consumers 102 that may be suitable for the identification of the plurality of consumers 102. In an exemplary embodiment, the consumer identifier may not be personally identifiable of any of the associated plurality of consumers 102.

In some embodiments, the associated plurality of consumers 102 may be a microsegment of consumers. A microsegment may be a group of consumers that is granular enough to be valuable to advertisers, marketers, offer providers, merchants, retailers, etc., but still maintain a high level of consumer privacy without the use or obtaining of personally identifiable information. Additional information regarding microsegments may be found in U.S. patent application Ser. No. 13/437,987, entitled “Protecting Privacy in Audience Creation,” by Curtis Villars et al., filed on Apr. 3, 2012, and U.S. patent application Ser. No. 13/438,346, entitled “Method and System for Measuring Advertising Effectiveness Using Microsegments,” by Curtis Villars, filed on Apr. 3, 2012, which are herein incorporated by reference in their entirety. In some embodiments, the consumer identifier included in each click data entry 210 may be at least one of: a microsegment identifier, a geographic area, a set of demographic values, a set of microsegment values, a set of device identifiers, and a set of consumer identification values.

The receiving unit 202 may be further configured to receive transaction data from the payment network 112 or other suitable source (e.g., a point of sale system of the merchant 110). The received transaction data may be comprised of a plurality of transaction data entries, each transaction data entry including data related to a payment transaction including at least common merchant data and a common consumer identifier. The common consumer identifier may be a consumer identifier that is included in a click data entry 210. For example, in instances where the consumer identifier is a microsegment identifier, the received transaction data entries may correspond to payment transactions involving a specific merchant 110 and any consumers 102 included in the microsegment associated with the microsegment identifier. In another example, the received transaction data entries may correspond to payment transactions involving the merchant 110 and consumers 102 located in a specific geographic area.

The processing unit 204 of the processing server 108 may be further configured to identify a specific click data entry 210 in the click database 208 that corresponds to the received transaction data where the included consumer identifier corresponds to the common consumer identifier. The web page advertisement related to the identified specific click data entry 210 may also be associated with the common merchant data. In such an instance, the processing unit 204 may identify clicks that corresponds to processed payment transactions. In some embodiments, the common merchant data may include a uniform resource locator (URL) or hyperlink associated with the related web page advertisement. The processing unit 204 may also be configured to calculate a conversion rate for the web page advertisement based on the number of clicks included in the specific click data entry 210 and a number of the received transaction data entries.

In some embodiments, the processing server 108 may use impressions in place of clicks for a web page or other electronic advertisement, where impressions may be instances where the advertisement is within viewing space of the consumer 102. In such an embodiment, impressions may be used in place of clicks where applicable as discussed herein. In these instances, the processing unit 204 may calculate a conversion rate based on the number of impressions included in a specific click data entry 210. The use of impressions in place of clicks when calculating conversion rates will be apparent to persons having skill in the relevant art.

The processing server 108 may also include a consumer database 212. The consumer database 212 may be configured to store a plurality of consumer profiles 214. Each consumer profile 214 may include data related to a consumer 102 including at least an advertisement clicking history. The advertisement clicking history may correspond to a plurality of webpage advertisements clicked on by the related consumer 102. The processing unit 204 may be configured to identify a number of consumer profiles 214 that include a common advertisement clicking history.

The processing server 108 may further include a transmitting unit 206. The transmitting unit 206 may be configured to transmit data over one or more networks via one or more network protocols. The transmitting unit 206 may transmit a purchase history request to another entity, such as to the payment network 112. The purchase history request may include the common advertisement clicking history identified by the processing unit 204. In some embodiments, the purchase history request may include a plurality of merchant identifiers, where each merchant identifier is associated with a merchant 110 and corresponds to an advertisement included in the common advertisement clicking history.

The receiving unit 202 may receive a response to the purchase history request, which may be comprised of at least a number of consumers 102 associated with payment transactions corresponding to the common advertisement clicking history. For example, the advertisement clicking history may indicate clicks for advertisements to three different merchants 110, and the number of consumers received by the receiving unit 202 may correspond to consumers involved in payment transactions involving each of the three different merchants 110. The processing unit 204 may be configured to calculate a conversion rate based on the number of consumers received by the receiving unit 202 and the identified number of consumer profiles 214.

In some embodiments, the advertisement clicking history for a consumer profile 214 may be based on a data file received by the receiving unit 202, such as a cookie. In such an embodiment, the receiving unit 202 may receive a data file including a specific consumer identifier and an indication of a clicked webpage advertisement. The processing unit 204 may identify a corresponding consumer profile 214 based on the consumer identifier and may update the advertisement clicking history based on the indicated clicked webpage advertisement. In some embodiments, the consumer identifier may be at least one of: an internet protocol (IP) address, a media access control (MAC) address, and a unique identification value associated with the computing device 104.

In some embodiments, the receiving unit 202 may receive data regarding one or more subsets of the consumers received in response to the purchase history request. In such an embodiment, the subsets of consumers may correspond to consumers associated with purchase transactions involving a subset of the common advertisement clicking history. For example, if the advertisement clicking history includes three merchants 110, the data received by the receiving unit 202 may indicate a number of consumers involved in purchase with all three merchants 110, and numbers of consumers involved in purchases of different combinations of two of the three merchants 110.

In some embodiments, each click data entry 210 may include clicks associated with one or more computing devices 104. In such an embodiment, the click data entry 210 may include a device identifier of a plurality of device identifiers. The plurality of device identifiers may correspond to computing devices 104 associated with a plurality of consumers 102, such as a microsegment of consumers 102. The receiving unit 202 may be configured to receiving a plurality of clearing indications from the payment network 112. Each clearing indication may be associated with a device identifier of the plurality of device identifiers and may indicate non-existence of a clearing record for a payment transaction associated with a computing device 104 associated with the respective identifier. As such, the records may indicate computing devices 104 for which there is no associated clearing record for a payment transaction.

The processing unit 204 may be configured to identify, in the click database 208, a subset of the plurality of click data entries 210 where each click data entry 210 in the subset includes a device identifier associated with a clearing indication of the received plurality of clearing indications. The processing unit 204 may then indicate in each of the identified click data entries 210 in the subset that the associated click is a fraudulent consumer click of the related webpage advertisement. In some embodiments, each click data entry 210 may include a click time and/or date, and the clearing indications may indicate non-existence of a clearing record during a predetermined period of time including the click time and/or date of each click data entry 210.

In some embodiments, each click data entry 210 may correspond to a specific consumer click of a webpage advertisement and may include at least a unique transaction identifier and a flag indicating conversion of the related consumer click. The unique transaction identifier may be a transaction number, transaction time and/or date, payment account number, merchant identifier, confirmation number, URL, username, IP address, MAC address, combination thereof, or other value suitable for identification of a specific payment transaction. The transmitting unit 206 may be configured to transmit a verification request to the payment network 112, where the verification request includes at least the unique transaction identifier included in each click data entry 210.

The receiving unit 202 may receive a verification response from the payment network 112 in response to the transmitted verification request. The verification response may include a subset of unique transaction identifiers, wherein each identifier in the subset is identified as not corresponding to a clearing record for a payment transaction. For example, the transaction identifiers included in the subset may correspond to payment transactions that were approved during processing (e.g., by an issuer) but were not cleared, such as due to actions by an involved merchant 110. The processing unit 204 may be configured to update the flag each click data entry 210 that includes a unique transaction identifier included in the received subset to indicate non-conversion of the related consumer click.

The processing server 108 may also include a memory 216. The memory 216 may be configured to store data used for performing one or more functions disclosed herein. For instance, the memory 216 may include algorithms used by the processing unit 204 to calculate conversion rates based on data received and/or stored therein. Additional data that may be stored in the memory 216 will be apparent to persons having skill in the relevant art.

### Process for Identifying Fraudulent and Unconverted Clicks

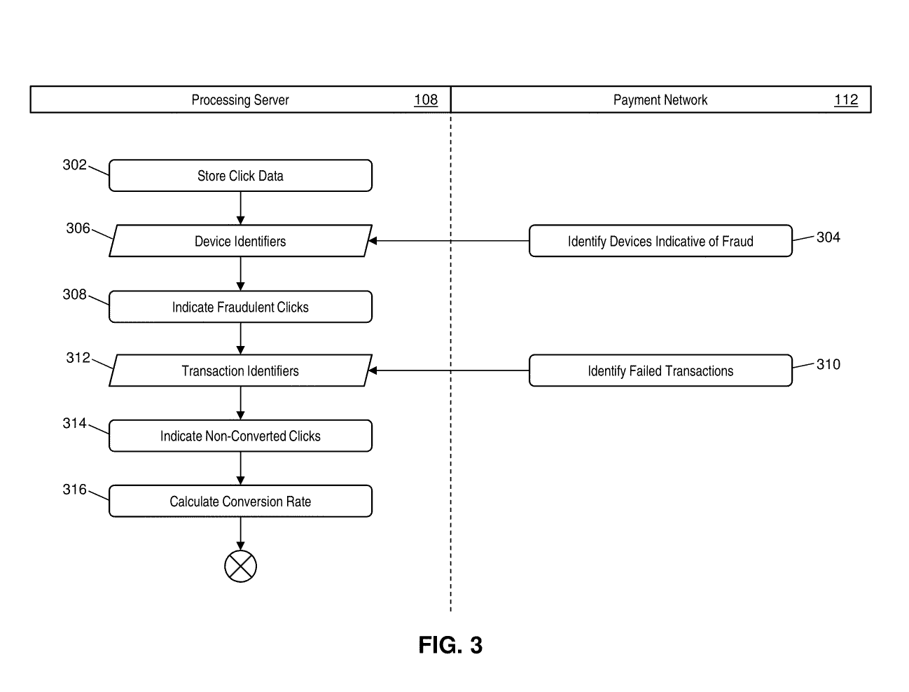

FIG. 3 illustrates a process of the processing server 108 of the system 100 of FIG. 1 for identifying fraudulent and unconverted clicks.

In step 302, the processing unit 204 of the processing server 108 may store click data in a click database 208 as a plurality of click data entries 210. Each click data entry 210 may include data related to one or more clicks by a consumer 102 (e.g., via a computing device 104) of a webpage advertisement. Each click data entry 210 may include at least a device identifier associated with the computing device 104 used to make the click. In some embodiments, each click data entry 210 may also include a flag, which may indicate that the related click was converted or not converted into a payment transaction. In instances where a click is flagged as a conversion, the click data entry 210 may also include a unique transaction identifier.

In step 304, the payment network 112 may identify computing devices 104 indicative of fraud. Identification of the computing devices 104 indicative of fraud may include identifying computing devices 104 for which there is no associated clearing record. In some embodiments, the payment network 112 may first receive (e.g., from the transmitting unit 206 of the processing unit 108) a list of computing device identifiers. The payment network 112 may then identify a subset of the list of computing device identifiers including those computing device identifiers for which there is no associated clearing record.

In step 306, the device identifiers corresponding to computing devices 104 that do not have an associated clearing record may be transmitted to the processing server 108 and received by the receiving unit 202. In step 308, the processing unit 204 may identify click data entries 210 that include a device identifier corresponding to the received device identifiers and may indicate in the click database 208 the respective click data entries 210 as being fraudulent clicks. In some embodiments, the identified click data entries 210 may include a flag indicating the clicks as fraudulent.

In step 310, the payment network 112 may identify failed payment transactions. Failed payment transactions may be payment transactions that have been authorized, but for which there is no corresponding clearing record. The payment network 112 may identify a unique transaction identifier for each of the failed payment transactions. In some embodiments, the payment network 112 may first receive a list of unique transaction identifiers from the processing server 108 (e.g., via the transmitting unit 206) and may identify unique transaction identifiers from the received list for which there is no corresponding clearing record. The identified unique transaction identifiers may then be transmitted to the processing server 108, which may receive (e.g., via the receiving unit 202) the identified unique transaction identifiers, in step 312.

In step 314, the processing unit 204 may update the flag click data entries 210 that include one of the received identified unique transaction identifiers to indicate the corresponding related click as being a non-converted click. In step 316, the processing unit 204 of the processing server 108 may calculate a conversion rate for a webpage advertisement based on the stored click data and indications of fraudulent and converted or non-converted clicks using methods that will be apparent to persons having skill in the relevant art. In some embodiments, the processing unit 204 of the processing server 108 may use transaction data to calculate the conversion rate, using methods discussed below.

### Processes for Calculating Click Conversion Rates

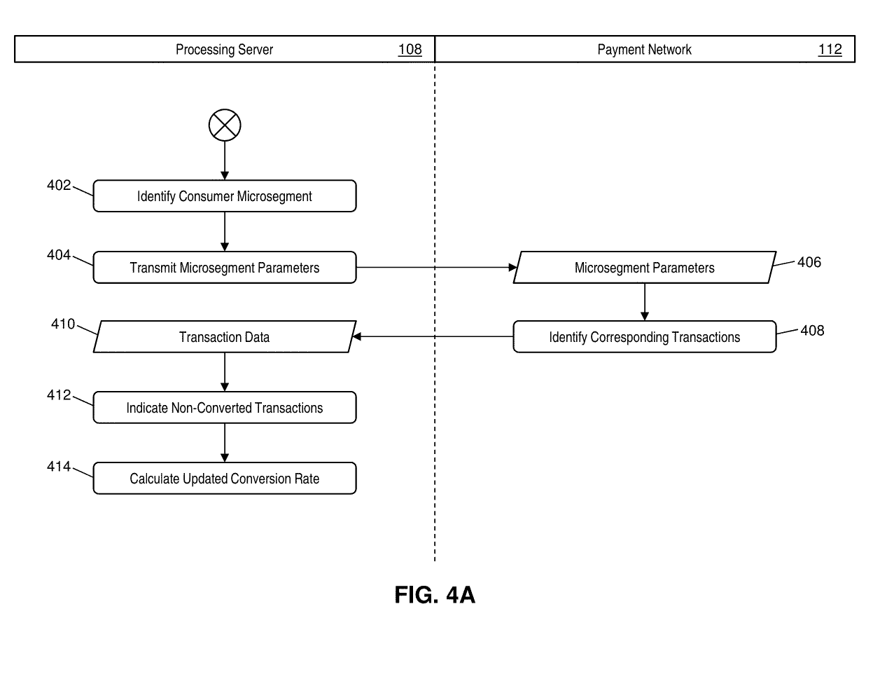

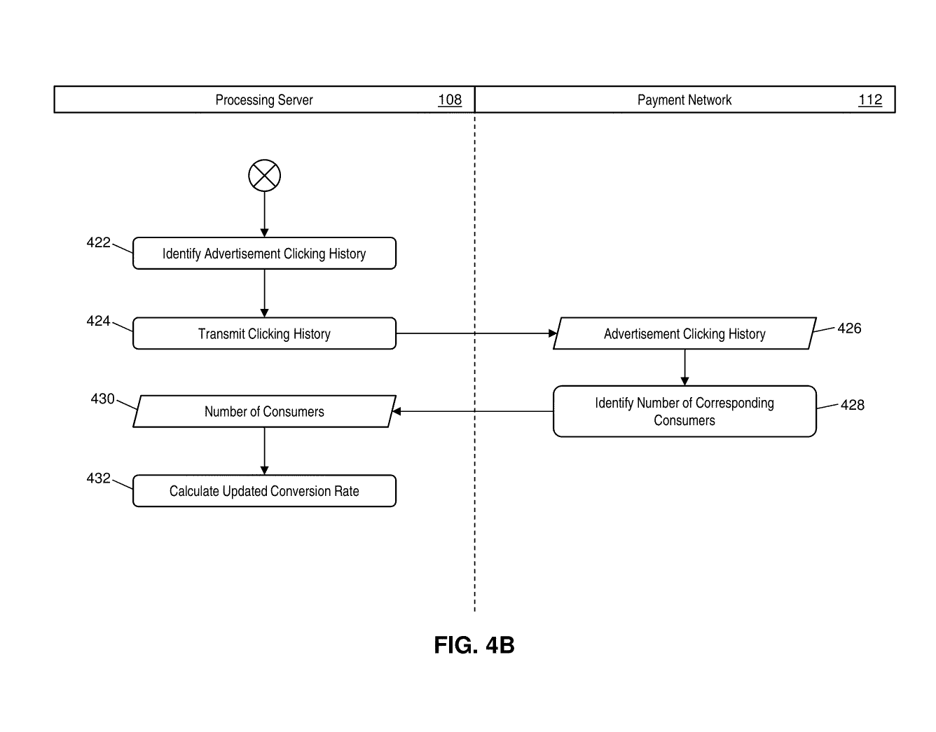

FIGS. 4A and 4B illustrate embodiments of processes for calculating click conversion rates, such as by using click data entries 210 stored in the click database 208 as illustrated in step 302 of FIG. 3 and discussed above. It will be apparent to persons having skill in the relevant art that, although the processes illustrated in FIGS. 4A and 4B are illustrated as occurring after steps 302-316 of FIG. 3, the processes illustrated in each of FIGS. 4A and 4B may be performed independently or in conjunction with other alternative, or additional processes, to calculate click conversion rates.

In a first embodiment, as illustrated in FIG. 4A, in step 402, the processing unit 204 of the processing server 108 may identify a microsegment of consumers 102. Identification of the microsegment of consumers 102 may include identifying an identifier and/or one or more parameters of the microsegment. In step 404, the transmitting unit 206 of the processing server 108 may transmit parameters corresponding to the identified microsegment of consumers 102 to the payment network 112. In an example, the parameters may be a plurality of geographic and/or demographic characteristics associated with each of the consumers included in the microsegment.

In step 406, the payment network 112 may receive the microsegment parameters. In step 408, the payment network 112 may identify payment transactions that involve consumers 102 included in the microsegment of consumers 102 based on the received parameters. In an example, the microsegment parameters may include a geographic area, and the payment network 112 may identify payment transactions involving consumers 102 or merchants 110 located in the geographic area. In an exemplary embodiment, the payment network 112 may only identify Internet-based payment transactions. In some embodiments, the parameters provided to the payment network 112 may include a merchant 110 (e.g., associated with the webpage advertisement). In such an embodiment, the identified payment transactions may involve the merchant 110. Once the payment transactions have been identified, the payment network 112 may then transmit transaction data corresponding to the identified payment transactions to the processing server 108.

In step 410, the receiving unit 202 of the processing server 108 may receive the transaction data from the payment network 112. The transaction data may include at least a number of payment transactions. In some embodiments, the transaction data may include data related to each of the identified payment transactions, such as time and/or date data, merchant data, etc. In step 412, the processing unit 204 may indicate transactions included in or accounted for by the received transaction data that correspond to non-converted transactions, such as illustrated in steps 310-314 of FIG. 3. It will be apparent to persons having skill in the relevant art that step 412 may be an optional step. In step 414, the processing unit 204 may calculate an updated conversion rate for the webpage advertisement based on at least the number of click data entries 210 related to clicks by consumers 102 in the microsegment of consumers 102 and the number of transactions in the transaction data received from the payment network 112.

In another embodiment, as illustrated in FIG. 4B, in step 422, the processing server 108 may identify a common advertisement clicking history included in a plurality of consumer profiles 214 stored in the consumer database 212. The advertisement clicking history may include a plurality of webpage advertisements and/or their associated merchants 110 that have been clicked by each of the corresponding consumers 102. In step 424, the transmitting unit 206 of the processing server 108 may transmit the identified advertisement clicking history to the payment network 112. In step 426, the payment network 112 may receive the advertisement clicking history, which may include a plurality of merchants 110.

In step 428, the payment network 112 may identify a number of corresponding consumers 102. The number of corresponding consumers 102 may be a number of consumers 102 that have been involved in payment transactions with each of the merchants 110 indicated or included in the common advertisement clicking history. In some embodiments, the advertisement clicking history may include one or more predetermined periods of time, with the identified consumers 102 having been involved in payment transactions during the predetermined periods of time.

The payment network 112 may transmit the identified number of consumers 102 to the processing server 108, which may be received by the receiving unit 202, in step 430. In step 432, the processing unit 204 may calculate an updated conversion rate for one or more of the webpage advertisements included in the advertisement clicking history based on the received number of consumers and a number of consumers whose consumer profiles 214 include the common advertisement clicking history.

### Identification of Fraudulent and Unconverted Clicks

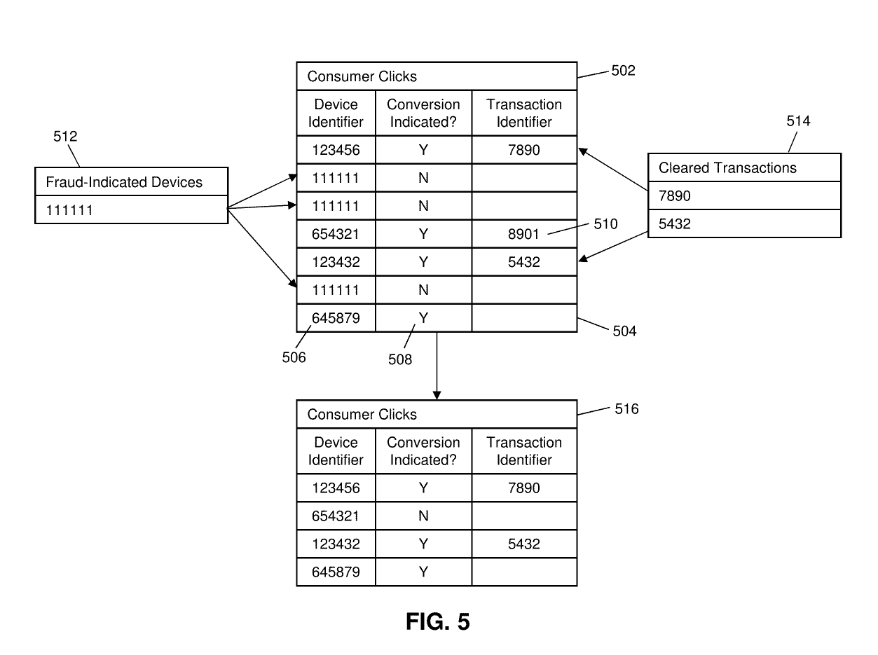

FIG. 5 illustrates the identification of fraudulent and unconverted clicks based on transaction data using the methods and systems discussed herein.

A click table 502 may include a plurality of consumer clicks 504. Each consumer click 504 may correspond to a click of a webpage advertisement by a consumer 102 using a computing device 104. In some instances, each consumer click 504 may correspond to a click data entry 210 stored in the click database 208 of the processing server 108. Each consumer click 504 may include a device identifier 506, a conversion flag 508, and a unique transaction identifier 510.

The device identifier 504 may be a unique identifier associated with a computing device 104 that was used to make the corresponding click of the webpage advertisement. The conversion flag 508 may be a flag used to indicate if the corresponding click was converted into a payment transaction with a merchant 110 associated with the webpage advertisement. The unique transaction identifier 510 may be a unique value associated with a payment transaction. As illustrated in FIG. 5, consumer clicks 504 that are not indicated as being converted into a payment transaction (e.g., by an “N” value of the conversion flag) may not have a unique transaction identifier 510.

The receiving unit 202 of the processing server 108 may receive a list of fraud-indicated devices 512. The list of fraud-indicated devices 512 may include one or more device identifiers that correspond to computing devices 104 that are indicated as being a source of fraudulent clicks. In one example, computing devices 104 included in the list of fraud-indicated devices 512 may be computing devices 104 for which there is no associated clearing record, such as in instances where a computing device 104 is not to conduct any payment transactions.

The processing unit 204 may identify consumer clicks 502 that include a device identifier 506 included in the list of fraud-indicated devices 512. As illustrated in FIG. 5, the click table 502 includes three consumer clicks 504 that correspond to clicks made via a computing device 104 indicated as fraudulent based on the list of fraud-indicated devices 512. The processing unit 204 may include an additional flag in each of the identified consumer clicks 504 indicating the clicks as being fraudulent, or, in some embodiments, such as illustrated in FIG. 5, may remove the consumer clicks 504.

The receiving unit 202 may also receive a list of cleared transaction identifiers 514. The list of cleared transaction identifiers 514 may include unique transaction identifiers for payment transactions for which there is an associated clearing record. Although it is illustrated that the processing server 108 may receive identifiers for transactions where there is an associated clearing record, it will be apparent to persons having skill in the relevant art that, in some instances, the processing server 108 may receive a list of unique transaction identifiers (e.g., comprised from the unique transaction identifiers 510 in the click table 502) for which there is no associated clearing record.

The processing unit 204 may identify consumer clicks 504 in the click table 502 that include a unique transaction identifier 510 that is not found in the list of cleared transaction identifiers 514. In the example illustrated in FIG. 5, the processing unit 204 may identify a single consumer click 504 that includes a unique transaction identifier 510, the identifier value 8901, that is not included in the list of cleared transaction identifiers 514. The processing unit 204 may determine that the corresponding consumer click 504 was therefore not converted, and may update the conversion flag 508 accordingly.

An updated table 516 illustrates the click table 502 after consumer clicks 504 that were identified as fraudulent were removed, and after updating of the conversion flags 508 based on the receive list of cleared transaction identifiers 514. In the example illustrated in FIG. 5, the updated table 516 has three consumer clicks 502 that were indicative of fraud removed, and the conversion flag 508 for a click by the computing device 104 having an identifier of 654321 updated to a value of “N.”

### First Exemplary Method for Calculating a Click Conversion Rate

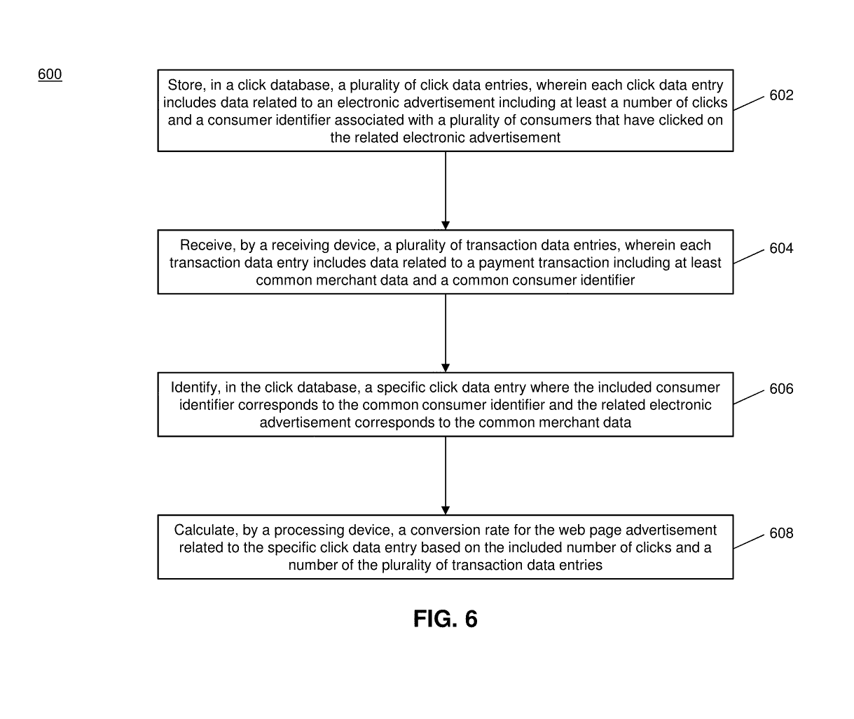

FIG. 6 illustrates a method 600 for the calculating of a click conversion rate based on transaction data.

In step 602, a plurality of click data entries (e.g., click data entries 210) may be stored in a click database (e.g., the click database 208), wherein each click data entry 210 includes data related to an electronic advertisement including at least a number of clicks and a consumer identifier associated with a plurality of consumers (e.g., consumers 102) that have clicked on the related electronic advertisement. In some embodiments, the plurality of consumers 102 may be a microsegment of consumers. In one embodiment, the consumer identifier may be at least one of: a microsegment identifier, a geographic area, a set of demographic values, a set of microsegment values, a set of device identifiers, and a set of consumer identification values.

In step 604, a plurality of transaction data entries may be received by a receiving device (e.g., the receiving unit 202), wherein each transaction data entry includes data related to a payment transaction including at least common merchant data and a common consumer identifier. In one embodiment, the common merchant data may include a URL or hyperlink associated with the electronic advertisement related to the identified specific click data entry.

In step 606, a specific click data entry 210 may be identified in the click database 208 where the included consumer identifier corresponds to the common consumer identifier and the related electronic advertisement corresponds to the common merchant data. In step 608, a conversion rate for the electronic advertisement related to the specific click data entry 210 may be calculated by a processing device (e.g., the processing unit 204) based on the included number of clicks and a number of the plurality of transaction data entries.

### Second Exemplary Method for Calculating a Click Conversion Rate

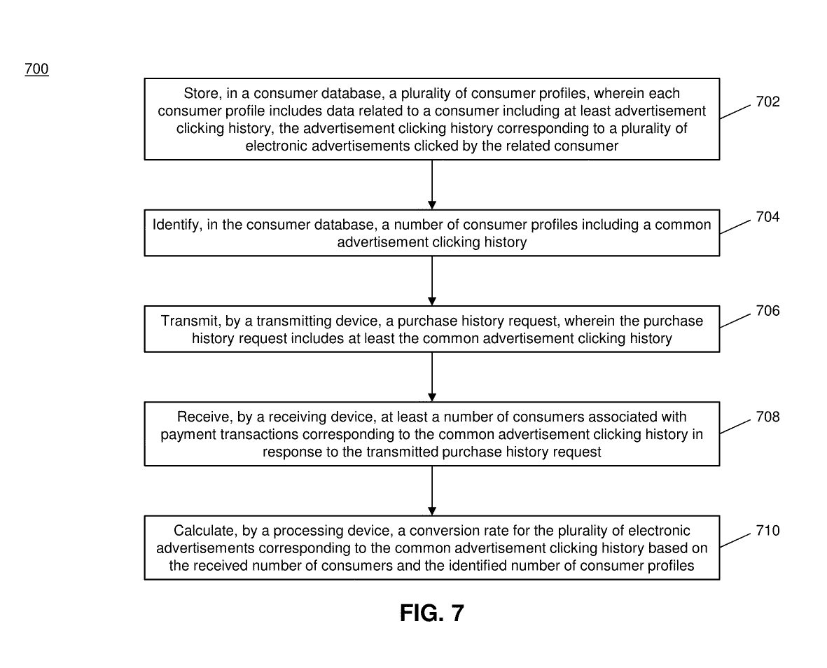

FIG. 7 illustrates a method 700 for the calculating of a click conversion rate based on transaction data.

In step 702, a plurality of consumer profiles (e.g., consumer profiles 214) may be stored in a consumer database (e.g., the consumer database 212), wherein each consumer profile 214 includes data related to a consumer (e.g., the consumer 102) including at least advertisement clicking history, the advertisement clicking history corresponding to a plurality of electronic advertisements clicked by the related consumer 102. In step 704, a number of consumer profiles 214 including a common advertisement clicking history may be identified in the consumer database 212. In one embodiment, the common advertisement clicking history may include a merchant identifier associated with each of the corresponding plurality of electronic advertisements.

In step 706, a purchase history request may be transmitted by a transmitting device (e.g., the transmitting unit 206), wherein the purchase history request includes at least the common advertisement clicking history. In step 708, at least a number of consumers associated with payment transactions corresponding to the common advertisement clicking history may be received, by a receiving device (e.g., the receiving unit 202), in response to the transmitted purchase history request. In step 710, a conversion rate for the plurality of electronic advertisements corresponding to the common advertisement clicking history may be calculated by a processing device (e.g., the processing unit 204) based on the received number of consumers and the identified number of consumer profiles 214.

In one embodiment, each consumer profile 214 may further include a consumer identifier. In a further embodiment, the method 700 may also include: receiving, by the receiving device 202, a data file including at least a specific consumer identifier and an indication of a clicked electronic advertisement; identifying, in the consumer database 212, a specific consumer profile 214 where the included consumer identifier corresponds to the specific consumer identifier; and updating, in the specific consumer profile 214, the advertisement clicking history based on the indication of a clicked electronic advertisement. In an even further embodiment, the consumer identifier may be at least one of: an IP address, a MAC address, and a unique identification value associated with a computing device (e.g., the computing device 104).

In some embodiments, the method 700 may further include receiving, by the receiving device 202, a subset number of consumers associated with payment transactions corresponding to each of a plurality of subsets of the common advertisement clicking history in response to the transmitted purchase history request, wherein each subset of the common advertisement clicking history corresponds to the corresponding plurality of electronic advertisements. In a further embodiment, the method 700 may also include calculating, by the processing device 204, a conversion rate for each subset of the plurality of electronic advertisements based on the received subset number of consumers and the identifier number of consumer profiles 214.

### Exemplary Method for Identifying Fraudulent Clicks

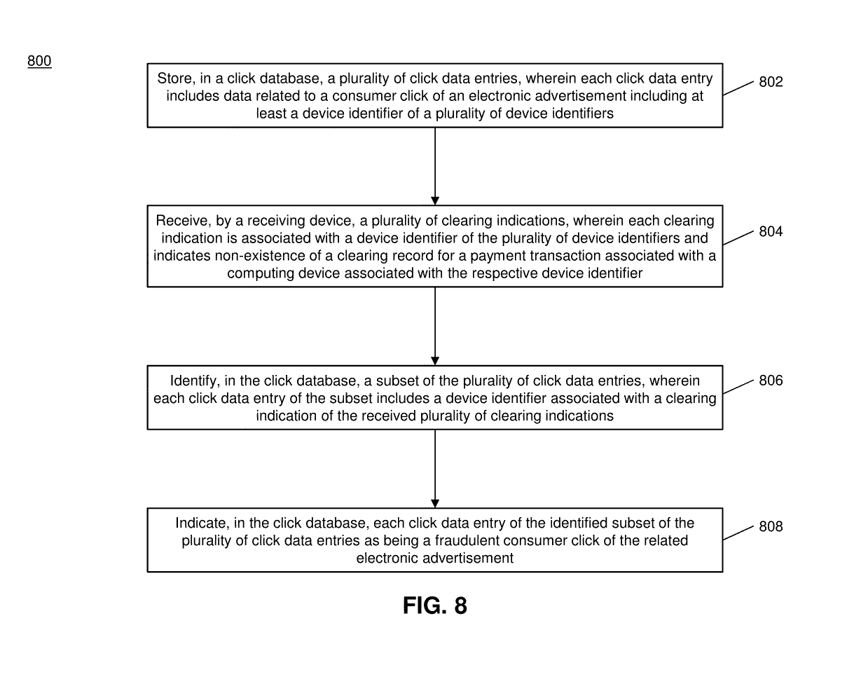

FIG. 8 illustrates a method 800 for identifying fraudulent clicks of an electronic advertisement based on transaction data.

In step 802, a plurality of click data entries (e.g., click data entries 210) may be stored in a click database (e.g., the click database 208), wherein each click data entry 210 includes data related to a consumer click of an electronic advertisement including at least a device identifier of a plurality of device identifiers. In one embodiment, the device identifier may be at least one of: an IP address, a MAC address, and a unique identification value associated with a computing device.

In step 804, a plurality of clearing indications may be received by a receiving device (e.g., the receiving unit 202), wherein each clearing indication is associated with a device identifier of the plurality of device identifiers and indicates non-existence of a clearing record for a payment transaction associated with a computing device (e.g., the computing device 104) associated with the respective device identifier. In one embodiment, the method 800 may further include transmitting, by a transmitting device (e.g., the transmitting unit 206), a request for clearing indications, wherein the request for clearing indications includes at least the plurality of device identifiers. In a further embodiment, the received plurality of clearing indications may be received in response to the transmitted request for clearing indications.

In some embodiments, each click data entry 210 may further include a click time and/or date during a predetermined period of time. In a further embodiment, each clearing indication may indicate non-existence of an authorization request or clearing record for a payment transaction associated with a computing device 104 associated with the respective device identifier during the predetermined period of time.

In step 806, a subset of the plurality of click data entries 210 may be identified, wherein each click data entry 210 of the subset includes a device identifier associated with a clearing indication of the received plurality of clearing indications. In step 808, each click data entry 210 of the identified subset of the plurality of click data entries 210 may be indicated, in the click database 208, as being a fraudulent consumer click of the related electronic advertisement. In one embodiment, the method 800 may further include calculating, by a processing device (e.g., the processing device 204), a conversion rate for the electronic advertisement based on a number of the plurality of click data entries and a number of click data entries in the identified subset of the plurality of click data entries.

### Exemplary Method for Identifying Unconverted Clicks

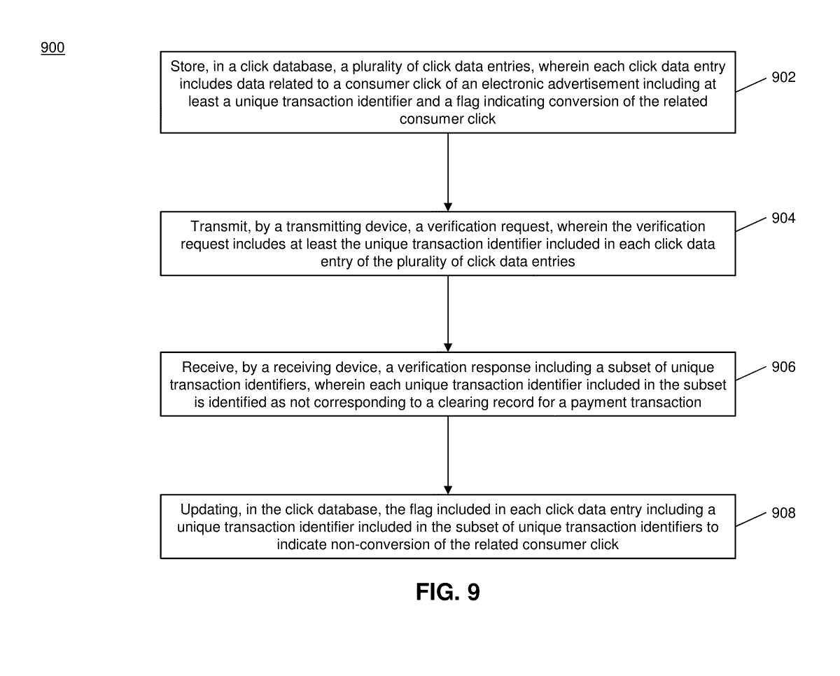

FIG. 9 illustrates a method 900 for identifying unconverted clicks of an electronic advertisement based on transaction data.

In step 902, a plurality of click data entries (e.g., click data entries 210) may be stored in a click database (e.g., the click database 208), wherein each click data entry 210 includes data related to a consumer click of an electronic advertisement including at least a unique transaction identifier and a flag indicating conversion of the related consumer click. In some embodiments, the unique transaction identifier may be at least one of: a transaction identification number, a transaction time and/or date, a consumer identifier, a payment account number, a merchant identifier, a confirmation number, a uniform resource locator, a username, an IP address, and a MAC address.

In step 904, a verification request may be transmitted by a transmitting device (e.g., the transmitting unit 206), wherein the verification request includes at least the unique transaction identifier included in each click data entry of the plurality of click data entries. In step 906, a verification response including a subset of unique transaction identifiers may be received by a receiving device (e.g., the receiving unit 202), wherein each unique transaction identifier included in the subset is identified as not corresponding to a clearing record for a payment transaction. In one embodiment, the verification request may be transmitted to a payment network (e.g., the payment network 112) and the verification response may be received from the payment network 112.

In step 908, the flag included in each click data entry 210 including a unique transaction identifier included in the subset of unique transaction identifiers may be updated, in the click database 208, to indicate non-conversion of the related consumer click. In some embodiments, the method 900 may further include calculating, by a processing device (e.g., the processing unit 204), a conversion rate based on a number of the plurality of click data entries 210 and a number of click data entries including a unique transaction identifier included in the subset of unique transaction identifiers.

### Computer System Architecture

FIG. 10 illustrates a computer system 1000 in which embodiments of the present disclosure, or portions thereof, may be implemented as computer-readable code. For example, the processing server 108 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4A, 4B, and 6-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3, 4A, 4B, and 6-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for calculating click conversion rates and identifying fraudulent and unconverted clicks. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for calculating a click conversion rate, comprising:
storing, in a click database, a plurality of click data entries, wherein each click data entry includes data related to an electronic advertisement including at least a number of clicks and a consumer identifier associated with a plurality of consumers that have clicked on the related electronic advertisement;
receiving, by a receiving device, a plurality of transaction data entries, wherein each transaction data entry includes data related to a payment transaction including at least common merchant data and a common consumer identifier;
identifying, in the click database, a specific click data entry where the included consumer identifier corresponds to the common consumer identifier and the related electronic advertisement corresponds to the common merchant data; and
calculating, by a processing device, a conversion rate for the electronic advertisement related to the specific click data entry based on the included number of clicks and a number of the plurality of transaction data entries.

2. The method of claim 1, wherein the plurality of consumers is a microsegment of consumers.

3. The method of claim 1, wherein the consumer identifier is at least one of: a microsegment identifier, a geographic area, a set of demographic values, a set of microsegment values, a set of device identifiers, and a set of consumer identification values.

4. The method of claim 1, wherein the common merchant data includes a uniform resource locator or hyperlink associated with the electronic advertisement related to the identified specific click data entry.

5. A method for calculating a click conversion rate, comprising:
storing, in a consumer database, a plurality of consumer profiles, wherein each consumer profile includes data related to a consumer including at least advertisement clicking history, the advertisement clicking history corresponding to a plurality of electronic advertisements clicked by the related consumer;
identifying, in the consumer database, a number of consumer profiles including a common advertisement clicking history;
transmitting, by a transmitting device, a purchase history request, wherein the purchase history request includes at least the common advertisement clicking history;
receiving, by a receiving device, at least a number of consumers associated with payment transactions corresponding to the common advertisement clicking history in response to the transmitted purchase history request; and
calculating, by a processing device, a conversion rate for the plurality of electronic advertisements corresponding to the common advertisement clicking history based on the received number of consumers and the identified number of consumer profiles.

6. The method of claim 5, wherein the common advertisement clicking history includes a merchant identifier associated with each of the corresponding plurality of electronic advertisements.

7. The method of claim 5, wherein each consumer profile further includes a consumer identifier, and the method further comprises:
receiving, by the receiving device, a data file including at least a specific consumer identifier and an indication of a clicked electronic advertisement;
identifying, in the consumer database, a specific consumer profile where the included consumer identifier corresponds to the specific consumer identifier; and
updating, in the specific consumer profile, the advertisement clicking history based on the indication of a clicked electronic advertisement.

8. The method of claim 7, wherein the consumer identifier is at least one of: an internet protocol address, a media access control address, and a unique identification value associated with a computing device.

9. The method of claim 5, further comprising:
receiving, by the receiving device, a subset number of consumers associated with payment transactions corresponding to each of a plurality of subsets of the common advertisement clicking history in response to the transmitted purchase history request, wherein each subset of the common advertisement clicking history corresponds to a subset of the corresponding plurality of electronic advertisements.

10. The method of claim 9, further comprising:
calculating, by the processing device, a conversion rate for each subset of the plurality of electronic advertisements based on the received subset number of consumers and the identified number of consumer profiles.

11. A system for calculating a click conversion rate, comprising:
a click database configured to store a plurality of click data entries, wherein each click data entry includes data related to an electronic advertisement including at least a number of clicks and a consumer identifier associated with a plurality of consumers that have clicked on the related electronic advertisement;
a receiving device configured to receive a plurality of transaction data entries, wherein each transaction data entry includes data related to a payment transaction including at least common merchant data and a common consumer identifier; and
a processing device configured to
identify, in the click database, a specific click data entry where the included consumer identifier corresponds to the common consumer identifier and the related electronic advertisement corresponds to the common merchant data, and
calculate a conversion rate for the electronic advertisement related to the specific click data entry based on the included number of clicks and a number of the plurality of transaction data entries.

12. The system of claim 11, wherein the plurality of consumers is a microsegment of consumers.

13. The system of claim 11, wherein the consumer identifier is at least one of: a microsegment identifier, a geographic area, a set of demographic values, a set of microsegment values, a set of device identifiers, and a set of consumer identification values.

14. The system of claim 11, wherein the common merchant data includes a uniform resource locator or hyperlink associated with the electronic advertisement related to the identified specific click data entry.

15. A system for calculating a click conversion rate, comprising:
a consumer database configured to store a plurality of consumer profiles, wherein each consumer profile includes data related to a consumer including at least advertisement clicking history, the advertisement clicking history corresponding to a plurality of electronic advertisements clicked by the related consumer;
a processing device configured to identify, in the consumer database, a number of consumer profiles including a common advertisement clicking history;
a transmitting device configured to transmit a purchase history request, wherein the purchase history request includes at least the common advertisement clicking history; and
a receiving device configured to receive at least a number of consumers associated with payment transactions corresponding to the common advertisement clicking history in response to the transmitted purchase history request, wherein
the processing device is further configured to calculate a conversion rate for the plurality of electronic advertisements corresponding to the common advertisement clicking history based on the received number of consumers and the identified number of consumer profiles.

16. The system of claim 15, wherein the common advertisement clicking history includes a merchant identifier associated with each of the corresponding plurality of electronic advertisements.

17. The system of claim 15, wherein
each consumer profile further includes a consumer identifier,
the receiving device is further configured to receive a data file including at least a specific consumer identifier and an indication of a clicked electronic advertisement, and
the processing device is further configured to
identify, in the consumer database, a specific consumer profile where the included consumer identifier corresponds to the specific consumer identifier, and
update, in the specific consumer profile, the advertisement clicking history based on the indication of a clicked web page advertisement.

18. The system of claim 17, wherein the consumer identifier is at least one of: an internet protocol address, a media access control address, and a unique identification value associated with a computing device.

19. The system of claim 15, wherein the receiving device is further configured to receive a subset number of consumers associated with payment transactions corresponding to each of a plurality of subsets of the common advertisement clicking history in response to the transmitted purchase history request, wherein each subset of the common advertisement clicking history corresponds to a subset of the corresponding plurality of electronic advertisements.

20. The system of claim 19, wherein the processing device is further configured to calculate a conversion rate for each subset of the plurality of electronic advertisements based on the received subset number of consumers and the identified number of consumer profiles.
